(19) United States
(12) Patent Application Publication
(10) Pub. No.: US 2015/0301279 A1
(43) Pub. Date: Oct. 22, 2015

(54) OPTICAL INTERCONNECTION DEVICE

(71) Applicant: V TECHNOLOGY CO., LTD., Yokohama-shi, Kanagawa (JP)

(72) Inventors: Koichi Kajiyama, Kanagawa (JP); Toshimichi Nasukawa, Kanagawa (JP); Masayasu Kanao, Kanagawa (JP); Shin Ishikawa, Kanagawa (JP)

(73) Assignee: V TECHNOLOGY CO., LTD., Kanagawa (JP)

(21) Appl. No.: 14/441,489

(22) PCT Filed: Oct. 3, 2013
(86) PCT No.: PCT/JP2013/076922

§ 371 Date: May 7, 2015

(30) Foreign Application Priority Data
Nov. 8, 2012 (JP) 2012-246684

(51) Int. Cl. G02B 6/122; G02B 6/134

(52) U.S. Cl. CPC G02B 6/122; G02B 6/134; G02B 2006/12169

(57) ABSTRACT

An optical interconnection device for transmitting and receiving an optical signal between a plurality of laminated semiconductor substrates. The optical interconnection device has a plurality of light emitting elements or a plurality of light receiving elements that are arranged in one of the semiconductor substrates and have pn junction parts using the semiconductor substrate as a common semiconductor layer. The light emitting element and the light receiving element, which form a pair and which transmit and receive an optical signal between the different semiconductor substrates, emit and receive light at a common wavelength.

### CROSS-REFERENCE TO RELATED APPLICATIONS

This application claims the benefit of International Application PCT/JP2013/076922, filed Oct. 3, 2013 and Japanese Patent Application JP2012-246684 filed Nov. 8, 2012, both of which are incorporated herein by reference in their entirety.

### TECHNICAL FIELD

The present invention generally relates to an optical interconnection device capable of achieving intra-chip optical interconnection.

### RELATED ART

The optical interconnection is widely available in the field of long-distance signal transmission using an optical fiber based on the utilization of characteristics such as high-speed, wide-bandwidth transmission, superior noise immunity, and a fine diameter of a cable. On the other hand, in order to further increase the information processing speed in the information processing device, extremely short distance optical interconnection between boards, chips, or in a chip is necessary, and a technology development for this has been advanced currently.

Basic elements in the short-distance optical interconnection are a light emitting element, an optical waveguide, and a light receiving element. The light emitting element drives light emitting based on a signal in a send circuit and outputs an optical signal. The optical waveguide transmits the output optical signal. The light receiving element receives the transmitted optical signal and outputs it to a receive circuit. Patent Literature 1 describes that optical coupling between a first optical device (light emitting element) mounted on a substrate and a second optical device (optical waveguide) formed on the substrate is performed with a curved mirror consisted of a part of an oval sphere formed on the substrate.

### RELATED ART LITERATURE

### Patent Literature

Patent Literature 1: Japanese Patent Application Publication No. 2001-141965

### SUMMARY OF THE INVENTION

In order to achieve the intra-chip optical interconnection, it is required to efficiently perform the optical coupling between the light emitting element or the light receiving element mounted on the substrate and the optical waveguide on the substrate. In the conventional art, an optical coupler has been used for this optical coupling between the light emitting element or the light receiving element and the optical waveguide. In this optical coupler, a deflection element such as a mirror, a prism, or a diffraction grating and a light condensing element such as a lens are required, and in order to obtain high optical coupling efficiency, a processing technique and a positioning technique with high accuracy are required in formation of the optical coupler. In the above-mentioned conventional art, a curved mirror obtained by integrating a light deflection element and a light condensing element is used. However, high accuracy in the formation is still required.

As described above, in order to achieve the intra-chip optical interconnection, an optical coupler which performs optical coupling between a light emitting element or a light receiving element and an optical waveguide with high coupling efficiency has been conventionally required. However, it is actually difficult to obtain such optical coupler. Thus, this has been a great obstacle to achieve the intra-chip optical interconnection.

One or more embodiments of the present invention may be an intra-chip optical interconnection with high efficiency by coupling between a light emitting element or a light receiving element and an optical waveguide formed in a substrate without using an optical coupler and the like.

The optical interconnection device according to one or more embodiments of the present invention includes: a Si semiconductor substrate; an optical waveguide formed on the Si semiconductor substrate; and a light emitting element formed at one end of the optical waveguide, wherein the light emitting element has a pn junction part obtained by performing an anneal treatment on a second semiconductor layer obtained by doping a first semiconductor layer in the Si semiconductor substrate with an impurity at high concentration, the anneal treatment being performed while irradiating the second semiconductor layer with light.

### Advantageous Effects of the Invention

In the optical interconnection device having such characteristics, the end of an optical waveguide formed on an Si semiconductor substrate includes a light emitting element including a pn junction part formed on the Si semiconductor substrate as a light emission part. Thus, an optical signal generated from the light emitting element can be introduced into the optical waveguide without using an optical coupler. Therefore, it becomes possible to achieve an intra-chip optical interconnection with high efficiency.

### BRIEF DESCRIPTION OF THE DRAWINGS

FIG. 1(a), FIG. 1(b), and FIG. 1(c) show explanatory views showing the optical interconnection device according to one or more embodiments of the present invention.

FIG. 2(a), FIG. 2(b), and FIG. 2(c) show explanatory views showing an example of a method for forming a light emitting element in the optical interconnection device according to one or more embodiments of the present invention.

FIG. 3(a), FIG. 3(b), and FIG. 3(c) show explanatory views showing an example of a method for forming an optical waveguide in the optical interconnection device according to one or more embodiments of the present invention.

FIG. 4(a), FIG. 4(b), and FIG. 4(c) show explanatory views showing the optical interconnection device according to one or more embodiments of the present invention.

FIG. 5(a) and FIG. 5(b) show explanatory views showing a structural example of a light receiving element in the optical interconnection device according to one or more embodiments of the present invention.

FIG. 6 is an explanatory view showing a light emitting drive part which outputs a light emission signal of a light emitting element and a light receiving detect part which outputs a light receiving signal of a light receiving element in the optical interconnection device according to one or more embodiments of the present invention.

### DETAILED DESCRIPTION

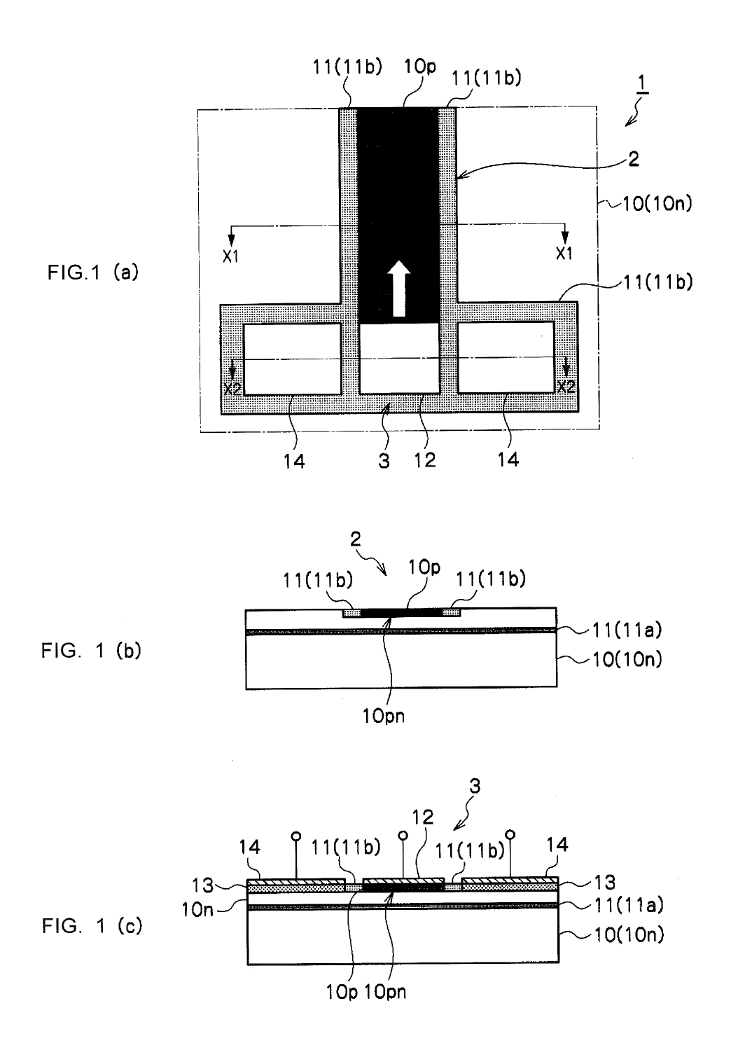

Embodiments of the present invention are described with reference to the drawings. FIG. 1 shows explanatory views showing the optical interconnection device according to one or more embodiments of the present invention. FIG. 1(a) is a plan view, FIG. 1(b) is an X1-X1 cross-sectional view in FIG. 1(a), and FIG. 1(c) is an X2-X2 cross-sectional view in FIG. 1(a).

An optical interconnection device 1 includes an Si semiconductor substrate 10, an optical waveguide 2 formed on the Si semiconductor substrate 10, and a light emitting element 3 formed at one end of the optical waveguide 2. In the Si semiconductor substrate 10, for example, an n-type first semiconductor layer 10n is formed. In the Si semiconductor substrate 10, a second semiconductor layer 10p obtained by doping the first semiconductor layer 10n with an impurity is further formed. The second semiconductor layer 10p is, for example, a p-type semiconductor layer.

In the vicinity of the interface between the first semiconductor layer 10n and the second semiconductor layer 10p, a pn junction part 10pn is formed. Insulation layers 11 are formed in the Si semiconductor substrate 10. In an example shown in FIG. 1, the insulation layers 11 include an inner insulation layer 11a formed inside the Si semiconductor substrate 10 and surface insulation layers 11b formed on the surface of the Si semiconductor substrate 10.

As shown in FIG. 1(b), in the optical waveguide 2, the second semiconductor layer 10p is used as an optical guide layer, and clad layers sandwiching the optical guide layer are formed of the surface insulation layers 11b on the Si semiconductor substrate 10. The surface insulation layers 11b as the clad layers are formed along the both sides of the second semiconductor layer 10p as the optical guide layer.

The light emitting element 3 includes, as a light emission part, the pn junction part 10pn formed in the vicinity of the interface between the first semiconductor layer 10n and the second semiconductor layer 10p. In an example shown in FIG. 1(c), a first electrode 12 is formed on the second semiconductor layer 10p, and second electrodes 14 are formed on n+ layers 13 formed outside the second semiconductor layer 10p via the surface insulation layers 11b. When a forward voltage to the pn junction part 10pn is applied between the first electrode 12 and the second electrodes 14, light is emitted from the pn junction part 10pn.

That is, the light emitting element 3 includes the first electrode 12 formed on the second semiconductor layer 10p, the second electrodes 14 formed on the first semiconductor layer 10n, and the pn junction part 10pn formed of the first semiconductor layer 10n and the second semiconductor layer 10p, and the first electrode 12 and the second electrodes 14 are arranged so as to sandwich the surface insulation layers 11b on one surface side of the Si semiconductor substrate 10. Although the second electrodes 14 are arranged on both sides of the first electrode 12 in the example shown in FIG. 1(c), the arrangement is not limited thereto, and the second electrodes 14 may be arranged on only one side of the first electrode 12.

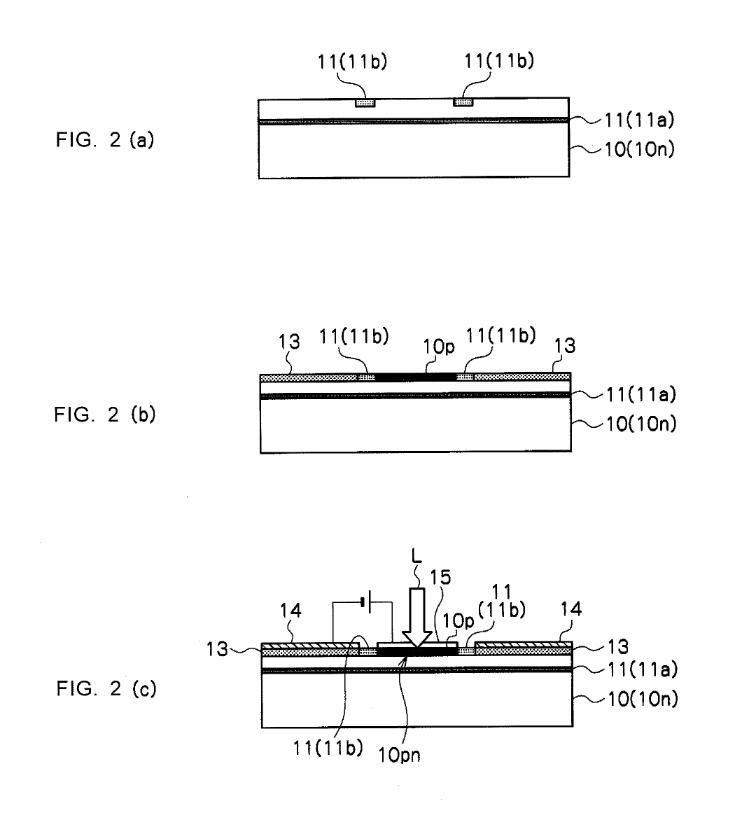

FIG. 2 shows explanatory views showing an example of a method for forming a light emitting element in the optical interconnection device according to one or more embodiments of the present invention. First, in an Si semiconductor substrate 10, a first semiconductor layer 10n doped with an impurity selected from, for example, arsenic (As), phosphorus (P), and antimony (Sb), which is a Group 15 element, is formed. The first semiconductor layer 10n is an n-type semiconductor layer.

Subsequently, as shown in FIG. 2(a), oxygen is injected or the like into the first semiconductor layer 10n to form insulation layers 11 being SiO₂ layers. In an example shown in FIG. 2(a), an inner insulation layer 11a is formed inside the first semiconductor layer 10n, and surface insulation layers 11b are formed on the surface of the first semiconductor layer 10n. The inner insulation layer 11a can be formed by injecting oxygen into the surface of the Si semiconductor substrate 10 and thereafter performing a thermal oxidation treatment to diffuse an SiO₂ layer inside the Si semiconductor substrate 10 or forming an SiO₂ layer on the surface of the Si semiconductor substrate 10 and thereafter forming an Si film on the surface. The surface insulation layers 11b can be formed by injecting oxygen into a mask through hole in a pattern formed by a photolithography process and thereafter performing a thermal oxidation treatment or the like.

Subsequently, as shown in FIG. 2(b), the outside of the surface insulation layers 11b is doped with an impurity selected from, for example, arsenic (As), phosphorus (P), and antimony (Sb), which is a Group 15 element, to form n+ layers 13, and doping with an impurity selected from, for example, boron (B), aluminum (Al), and gallium (Ga), which is a Group 13 element, is performed between the surface insulation layers 11b to form a second semiconductor layer (p-type semiconductor layer) 10p. Then, as shown in FIG. 2(c), second electrodes 14 are formed on the respective n+ layers 13, and a transparent electrode (ITO or the like) 15 is formed on the second semiconductor layer 10p. Thereafter, a forward voltage is applied between the second electrodes 14 and the transparent electrode 15, and the impurity (an impurity selected from, for example, boron (B), aluminum (Al), and gallium (Ga)) in the second semiconductor layer 10p is diffused by an anneal treatment using Joule heat of a current flowing through the pn junction part 10pn. Moreover, in the stage of this anneal treatment, the pn junction part 10pn is irradiated with light L to generate dressed photons in the vicinity of the pn junction part 10pn.

The Si semiconductor substrate itself is an indirect transition semiconductor and has low light emitting efficiency, cannot obtain useful light emission merely by forming a pn junction part, and has no light transmission properties in the visible light region. However, the Si semiconductor substrate 10 is subjected to annealing with the assistance of phonon to generate dressed photons in the vicinity of the pn junction part 10pn and change Si which is an indirect transmission-type semiconductor to as if it is a direct transition-type semiconductor, thereby achieving high-efficiency, high-output pn junction-type light emission. In order to obtain such pn junction-type light emission, doping with an impurity which is a Group 13 element such as boron (B) at high concentration is performed. An example of impurity doping conditions (in the case of boron (B)) at the time of the doping includes a dose density: 5*10¹³/cm², acceleration energy at the time of the injection: 700 keV, a wavelength of light L with which the irradiation is performed in the stage of the annealing: a desired wavelength band.

Thereafter, as shown in FIG. 1(c), the transparent electrode 15 is eliminated to form a first electrode 12 on the second semiconductor layer 10p. Thus, the light emitting element 3 including the pn junction part 10pn as a light emission part is formed. The light emitting element 3 emits light at the same wavelength as that of the light L with which the pn junction part 10pn is irradiated in the stage of the annealing by applying a voltage between the first electrode 12 and the second electrodes 14.

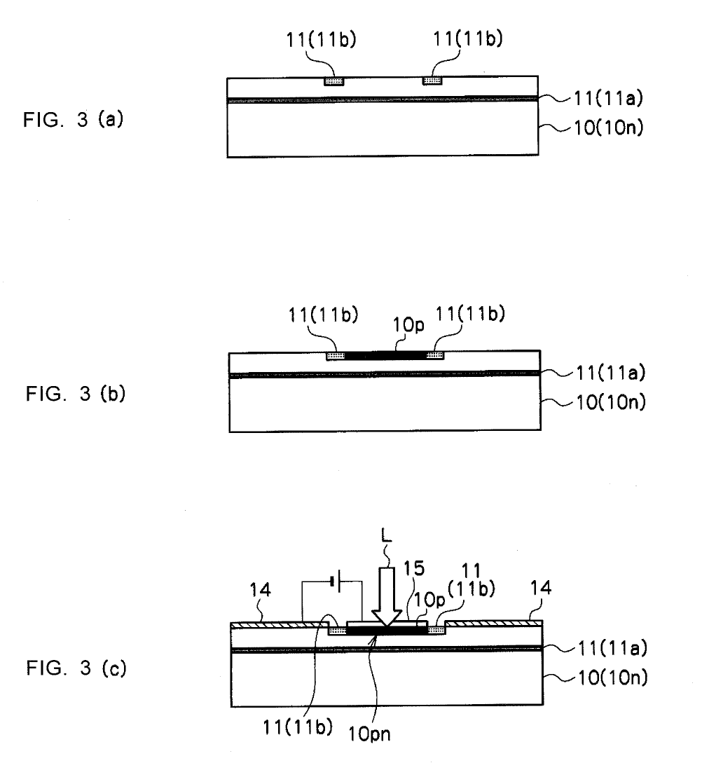

FIG. 3 shows explanatory views showing an example of a method for forming an optical waveguide in the optical interconnection device according to one or more embodiments of the present invention. A process shown in FIG. 3(a) is performed by the same process as shown in FIG. 2(a), an inner insulation layer 11a is formed inside a first semiconductor layer 10n, and surface insulation layers 11b are formed on the surface of the first semiconductor layer 10n. Subsequently, a process shown in FIG. 3(b) is performed by the same process as shown in FIG. 2(b), and in this stage, the n+ layers 13 are not formed, and a second semiconductor layer 10p is formed between the surface insulation layers 11b.

A process shown in FIG. 3(c) is performed by the same process as shown in FIG. 2(c), second electrodes 14 are formed on the first semiconductor layer 10n outside the surface insulation layers 11b, a transparent electrode (ITO or the like) 15 is formed on a second semiconductor layer 10p. Thereafter, a forward voltage is applied between the second electrodes 14 and the transparent electrode 15, and the impurity which is a Group 13 element such as boron (B) is diffused by an anneal treatment using Joule heat of a current flowing through the pn junction part 10pn. Moreover, in the stage of this anneal treatment, the pn junction part 10pn is irradiated with light L to generate dressed photons in the vicinity of the pn junction part 10pn. Thereafter, as shown in FIG. 1(b), the second electrodes 14 and the transparent electrode 15 are eliminated. Thus, the optical waveguide 2 including the second semiconductor layer 10p as an optical guide layer and surface insulation layers 11b as clad layers is formed.

According to such optical interconnection device 1, since the optical waveguide 2 and the light emitting element 3 are fabricated on one Si semiconductor substrate 10, light emitted from the pn junction part 10pn of the light emitting element 3 is propagated through the second semiconductor layer 10p and is directly incident on the optical guide layer of the optical waveguide 2. At that time, in each of the second semiconductor layer 10p in the optical waveguide 2 and the second semiconductor layer 10p in the light emitting element 3, a pattern in formed by the same photolithography process. Thus, the optical waveguide 2 and the light emitting element 3 can be formed integrally without a specific positioning, and light emitted from the light emitting element 3 can be introduced into the optical waveguide 2 without any loss.

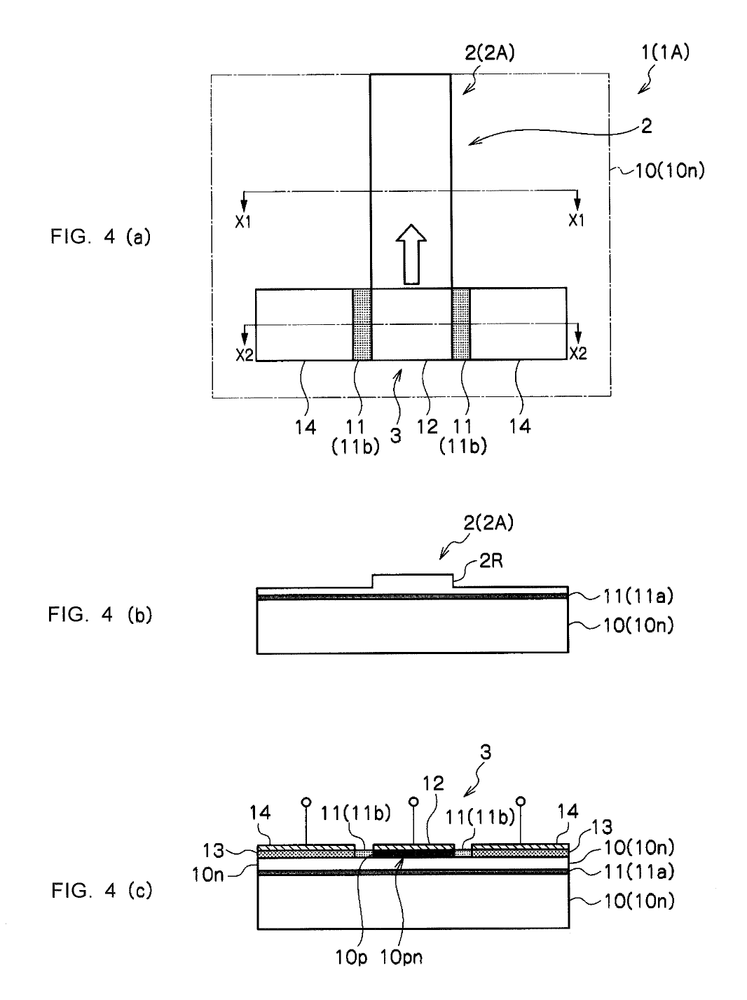

FIG. 4 shows explanatory views showing the optical interconnection device according to one or more embodiments of the present invention. FIG. 4(a) is a plan view, FIG. 4(b) is an X1-X1 cross-sectional view of FIG. 4(a), and FIG. 4(c) is an X2-X2 cross-sectional view of FIG. 4(a). The identical parts to those shown in FIG. 1 are denoted by identical reference numerals, and overlapping description is partially omitted.

An optical interconnection device 1 (1A) according to one or more embodiments is another embodiment of a structural example of an optical wave guide 2 (2A). In this example, a rib 2R is formed on the surface of a first semiconductor layer 10n to form a rib-type optical waveguide 2 (2A). In this case, a pattern of an etching mask for forming the rib 2R is formed on an extension of a pattern of the second semiconductor layer 10p in the light emitting element 3. Thus, a light axis of a pn junction part 10pn in the light emitting element 3 can agree with a light axis of the optical waveguide 2. In an example shown in FIG. 4, light propagating through the optical waveguide 2 is limited to infrared light which can transmit through an Si layer.

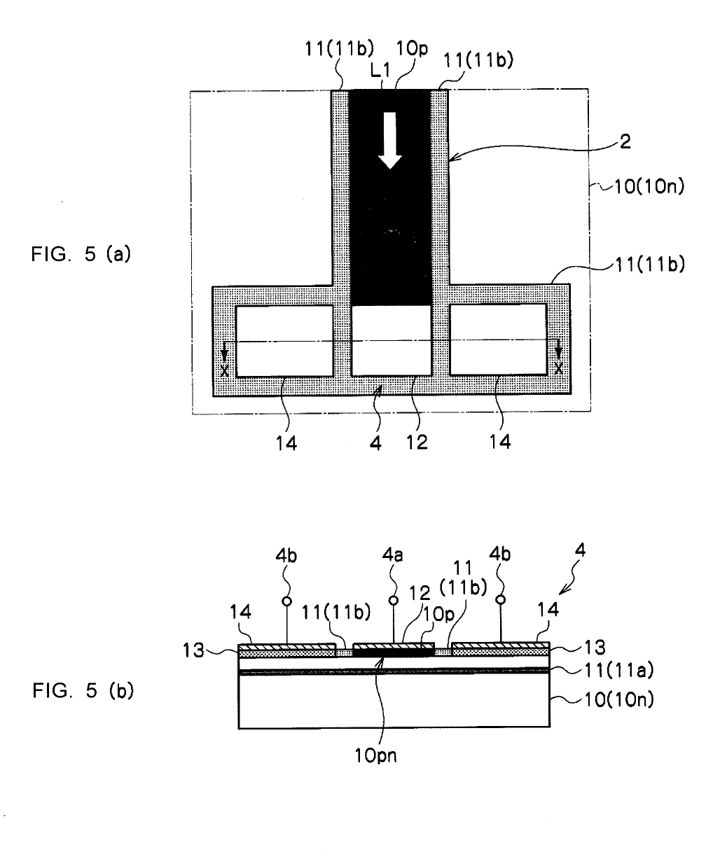

FIG. 5 shows explanatory views showing a structural example of a light receiving element in the optical interconnection device according to one or more embodiments of the present invention (FIG. 5(a) is a plan view, and FIG. 5(b) is an X-X cross-sectional view of FIG. 5(a)). A light receiving element 4 has a structure including the same pn junction part 10pn as in the light emitting element 3 as shown in FIG. 5(a) and FIG. 5(b) and can be formed by the same process as in the formation process shown in FIG. 2. The light receiving element 4 is formed at the other end of the optical waveguide 2 and has the pn junction part 10pn in an extension of the second semiconductor layer 10p in the optical waveguide 2. The light receiving element 4 applies a zero bias or a reverse bias between a terminal 4a connected to a first electrode 12 and terminals 4b connected to the respective second electrodes 14 and outputs a change in current generated by the incidence of the light L1 propagated through the optical waveguide 2.

That is, the light receiving element 4 includes the first electrode 12 formed on the second semiconductor layer 10p, the second electrodes 14 formed on the first semiconductor layer 10n, and the pn junction part 10pn formed of the first semiconductor layer 10n and the second semiconductor layer 10p, and the first electrode 12 and the second electrodes 14 are arranged so as to sandwich the surface insulation layers 11b on one surface side of the Si semiconductor substrate 10. Although the second electrodes 14 are arranged on the both sides of the first electrode 12 in the example shown in FIG. 5, the arrangement is not limited thereto, and the second electrodes 14 may be arranged on only one side of the first electrode 12. The light receiving element 4 is not limited to the example shown in FIG. 5 and can be formed of a light receiving element and the like mounted on or connected to the Si semiconductor substrate 10.

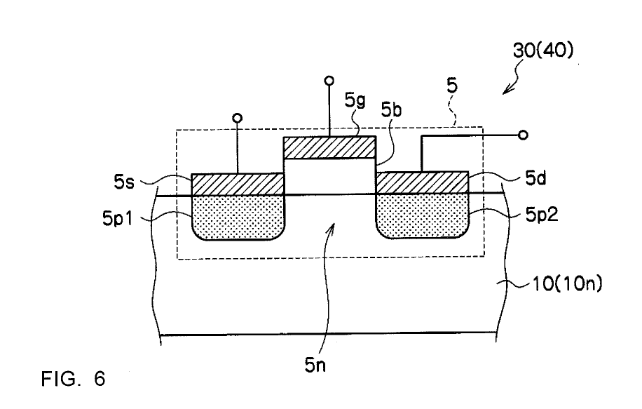

FIG. 6 is an explanatory view showing a light emitting drive part which outputs a light emission signal of a light emitting element and a light receiving detect part which outputs a light receiving signal of a light receiving element in the optical interconnection device according to one or more embodiments of the present invention. In the optical interconnection device 1, the Si semiconductor substrate 10 can include a light emitting drive part 30 which outputs a light emission signal of a light emitting element 3 or a light receiving detect part 40 which outputs a light receiving signal of a light receiving element 4. The light emitting drive part 30 or the light receiving detect part 40 can be consisted of a semiconductor element fabricated on the Si semiconductor substrate 10.

The light emitting drive part 30 or the light receiving detect part 40 can be consisted of a semiconductor element 5 such as a MOS-type transistor as shown in FIG. 6, for example. In the example shown in FIG. 6, a p-type semiconductor layers 5p1 and 5p2 are formed in an n-type semiconductor layer 10n of the Si semiconductor substrate 10, a source electrode 5s and a drain electrode 5d are formed on the p-type semiconductor layers 5pl and 5ps, respectively, and a gate electrode 5g is formed on a channel region 5n between the p-type semiconductor layers 5p1 and 5p2 via an insulating film 5b. Each of the drain electrode 5d, the gate electrode 5g, and the source electrode 5s is connected to an electrode wiring for driving the light emitting element 3 or the light receiving element 4. Such semiconductor element 5 can be fabricated on the Si semiconductor substrate 10 including the light emitting element 3 or the light receiving element 4 fabricated therein by a known semiconductor lithography process.

As described above, the optical interconnection device according to one or more of the embodiments of the present invention can achieve an intra-chip optical interconnection with high efficiency by coupling the light emitting element 3 or the light receiving element 4 formed in the semiconductor substrate and the optical waveguide 2 without using an optical coupler. In particular, the light emitting wavelength, the light transmission wavelength, and the light receiving wavelength can agree with one another by setting light with which irradiation is performed at the time of forming the optical waveguide 2, the light emitting element 3, and the pn junction part 10pn in the light receiving element 4 to be light at the same wavelength. The wavelength of the light used at that time can be selected from any wavelength in the near-infrared to near-ultraviolet region. Accordingly, intra-chip optical interconnection having less transmission loss and a less crosstalk can be achieved in any transmission band.

The above-mentioned optical waveguide 2 is not required to be linear and may be curved, bent, or branched into plural guides. The optical waveguide 2 may have a structure in which signals of one or plural light emitting elements 3 are connected to plural or one light receiving element 4.

Although the above-mentioned description is made with reference to an example of an Si semiconductor substrate, any of other semiconductor substrates which can be replaced with the Si semiconductor substrate can be used.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. An optical interconnection device comprising:
an Si semiconductor substrate;
an optical waveguide formed on the Si semiconductor substrate; and
a light emitting element formed at one end of the optical waveguide,
wherein the light emitting element has a pn junction part obtained by performing an anneal treatment on a second semiconductor layer obtained by doping a first semiconductor layer in the Si semiconductor substrate with an impurity at high concentration, the anneal treatment being performed while irradiating the second semiconductor layer with light.

2. The optical interconnection device according to claim 1,
wherein in the optical waveguide, the second semiconductor layer is used as an optical guide layer, and clad layers sandwiching the optical guide layer are formed in the Si semiconductor substrate.

3. The optical interconnection device according to claim 1, comprising:
a light receiving element formed at the other end of the optical waveguide,
wherein the light receiving element has the pn junction part.

4. The optical interconnection device according to claim 1,
wherein the first semiconductor layer is an n-type semiconductor layer obtained by doping the Si semiconductor substrate with a Group 15 element.

5. The optical interconnection device according to claim 4,
wherein the impurity is a material selected from Group 13 elements, and the second semiconductor layer is a p-type semiconductor layer.

6. The optical interconnection device according to claim 1,
wherein the Si semiconductor substrate comprises a light emitting drive part which outputs a light emission signal of the light emitting element, and the light emitting drive part is consisted of a semiconductor element fabricated on the Si semiconductor substrate.

7. The optical interconnection device according to claim 3,
wherein the Si semiconductor substrate comprises a light receiving detect part which outputs a light receiving signal of the light receiving element, and the light receiving detect part is consisted of a semiconductor element fabricated on the Si semiconductor substrate.

8. An optical interconnection device, comprising:
an optical waveguide comprising:
an optical guide layer formed of a second semiconductor layer obtained by doping a first semiconductor layer on a semiconductor substrate with an impurity; and
clad layers consisted of insulation layers formed along both sides of the optical guide layer, and
a light emitting or light receiving element comprising:
a first electrode formed on the second semiconductor layer;
second electrodes formed on the first semiconductor layer; and
a pn junction part formed of the first semiconductor layer and the second semiconductor layer, wherein
the first electrode and the second electrodes are arranged so as to sandwich the insulation layers on one surface side of the semiconductor substrate.

9. The optical interconnection device according to claim 2, comprising:
a light receiving element formed at the other end of the optical waveguide,
wherein the light receiving element has the pn junction part.
